(19) United States
(12) Patent Application Publication
(10) Pub. No.: US 2007/0222596 A1
(43) Pub. Date: Sep. 27, 2007

(54) Radio Frequency Identification System and Tag

(75) Inventors: Floris Kleijn, Warmond (NL); Puneet Sawhney, Orlando, FL (US); William Cook, Tampa, FL (US)

Correspondence Address: MICHAEL W. TAYLOR, P.O. BOX 3791, ORLANDO, FL, 32802-3791, US

(73) Assignee: Chep USA, Orlando, FL (US)

(21) Appl. No.: 11/277,068

(22) Filed: Mar. 21, 2006

(51) Int. Cl. G08B 13/14; G06Q 30/00

(52) U.S. Cl. 340/572.1; 235/385

(57) ABSTRACT

A system and method are provided for associating a plurality of objects using a single RFID tag. The RFID tag includes a first page and a second page. An interrogator communicates with a server to interrogate the first page and the second page, wherein the first page and the second page include data that identifies objects to be tracked by the radio frequency identification tag and wherein the identified objects are associated based on a relationship between the first page and the second page.

### FIELD OF THE INVENTION

The invention relates to radio frequency identification (RFID) systems for tracking objects. In particular, the invention relates to a system and method of using a single RFID tag to associate two or more tracked objects. More particularly, the invention relates to a system and method of using a single RFID tag to associate returnable transport items and products carried therein.

### BACKGROUND OF THE INVENTION

RFID systems are employed in a wide range of applications. A conventional RFID system typically includes at least one RFID transponder or tag, at least one RFID reader or interrogator, and at least one computer having application software.

RFID tags are used in supply chain management applications to identify and track objects from a point of manufacture to a retail point-of-sale, including during warehouse storage, transportation, and distribution. RFID tags may be affixed to selected objects, including products, returnable transport items, or other objects, to enable tracking of the objects.

At least one RFID interrogator may be deployed in the supply chain environment to interrogate RFID tags that are affixed to objects passing within a capture range of the RFID interrogator. Known RFID interrogators transmit radio frequency (RF) signals that are received by one or more RFID tags. The RFID tags respond to the transmitted RF signal with a return RF signal that includes information identifying objects to which the RFID tags are affixed. The RFID interrogator receives the information transmitted by the RFID tag and communicates the information to the at least one computer for subsequent processing.

In the supply chain environment, RFID tags are typically configured to store Electronic Product Code™ (EPC). EPCs are globally unique serial numbers that identify objects that travel in the supply chain. The EPC is built around a basic hierarchical idea that can be used to express a wide variety of different, existing numbering systems, like the EAN.UCC System Keys, UID, VIN, and other numbering systems.

For supply chains that transport public health and safety goods, such as a food supply chain, some Governments now mandate storing object tracking information. Additionally, for objects that travel together in the food supply chain, such as products and their corresponding returnable transport items, storing of object association information may be required along with storing of object tracking information. Currently, products and corresponding returnable transport items are tagged individually and software applications are employed to identify and store object association information.

While RFID technology enables interrogators to almost simultaneously interrogate and track multiple RFID tags affixed to objects that travel in commerce together, it is cumbersome and expensive to provide RFID tags on all objects that require traceability. Various other drawbacks exist with this system and with other systems known in the prior art.

### SUMMARY OF THE INVENTION

Various aspects of the invention overcome at least some of these and other drawbacks of existing systems. According to one embodiment, the invention provides a single RFID tag that is configured to associate multiple objects and corresponding returnable transport items. The single RFID tag includes a first page of EPC structured memory and at least a second page of EPC structured memory. The additional pages of EPC structured memory may include similar length and partition.

The invention further provides an RFID interrogator that communicates with a server to interrogate multiple pages of EPC structured memory that is stored on a single RFID tag. The RFID interrogator may communicate with a server to interrogate further extended memory for specific non-EPC applications.

The invention provides numerous advantages over and avoids many drawbacks of prior systems. These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should become apparent upon a reading of the following detailed description when taken in conjunction with the accompanying drawings, a brief description of which is included below.

### BRIEF DESCRIPTION OF THE DRAWINGS

The drawings appended hereto are intended to illustrate contemplated embodiments of the invention. The drawings are not intended to limit the invention solely to the embodiments illustrated and described.

FIG. 1 illustrates an RFID system diagram according to one embodiment of the present invention.

FIG. 2 illustrates a memory configured with 96 bit EPC with GTIN structure.

FIG. 3 illustrates an RFID tag that is configured with multiple pages of EPC 96 bit structure.

FIG. 4 illustrates a flow chart for associating two or more objects on a single RFID tag according to one embodiment of the invention.

FIG. 5 illustrates a flow chart for generating a single RFID tag that associates two or more objects, according to one embodiment of the invention.

### DETAILED DESCRIPTION OF THE INVENTION

While specific embodiments of the invention are discussed herein and are illustrated in the drawings appended hereto, the invention encompasses a broader spectrum than the specific subject matter described and illustrated. As would be appreciated by those skilled in the art, the embodiments described herein provide but a few examples of the broad scope of the invention. There is no intention to limit the scope of the invention only to the embodiments described.

RFID technology enables a system having wireless data communication capabilities for identifying objects that have RFID tags affixed thereto. RFID systems typically include data collection hardware components and software components that track objects as the objects move through the supply chain. Data collection hardware may include RFID transponders or tags, RFID readers or interrogators, among other data collection hardware.

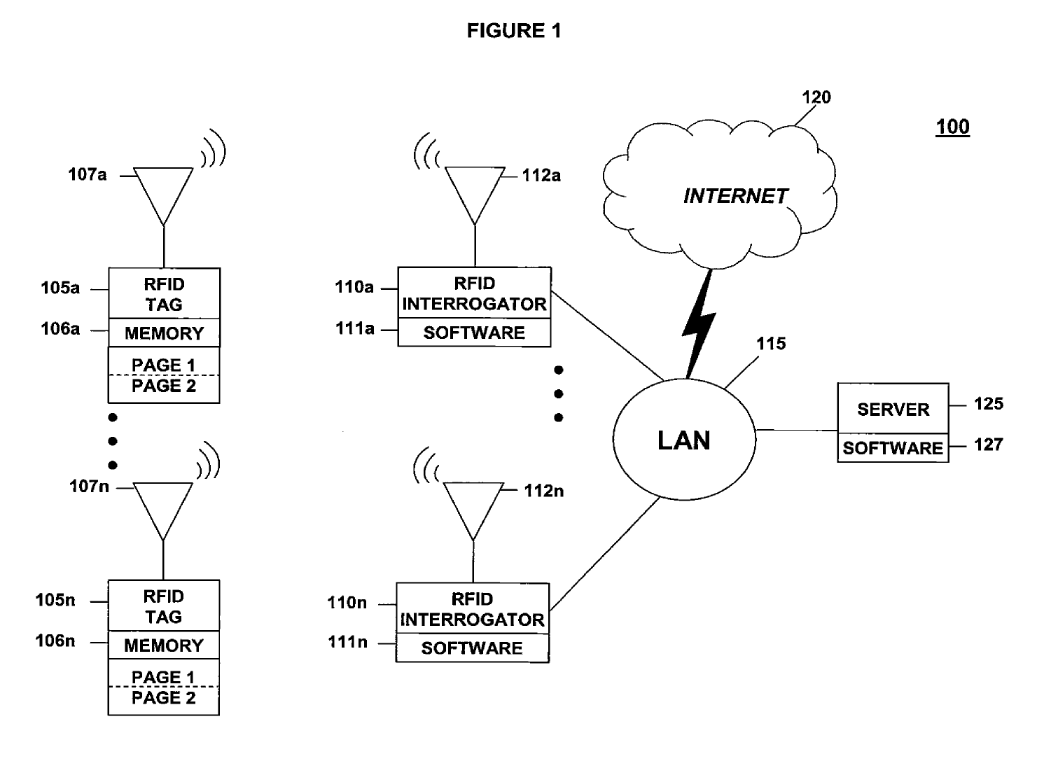

FIG. 1 illustrates a system architecture for an RFID system 100 according to one embodiment of the invention. RFID system 100 may include one or more RFID tags 105a-105n (hereinafter RFID tags 105), one or more RFID interrogators 110a-110n (hereinafter RFID interrogators 110), and a server 125 that is connected to the RFID interrogators 110 via a local area network (LAN) 115 and/or the Internet 120. According to one embodiment, LAN 115 may provide access to Internet 120.

RFID tags 105 may include microchips and antennas 107a-107n (hereinafter antenna 107), wherein antenna 107 receives RF signals from RFID interrogators 110, among other read/write devices. RFID tags 105 may include a memory 106a- 106n (hereinafter memory 106) that enables data to be written to and read from RFID tag 105. Memory 106 may store object information corresponding to the object affixed thereto, wherein object information may include object attributes, object dimensions, object price or other object information. Memory 106 may include two or more pages of structured memory. According to one embodiment, memory 106 may include a first page of structured memory having partitions or other structure and at least one additional page of structured memory having partitions or other structure. For example, one RFID tag 105 may include memory 106 that stores a second page of structured memory, a third page of structured memory, a fourth page of structured memory, and/or so forth. One of ordinary skill in the art will readily appreciate that memory 106 may include one or more memory components that operate together.

According to one embodiment of the invention, memory 106 may be divided into pre- selected portion sizes called pages. The pages size is typically defined based on a number of bytes. While the pages may be configured to be of different byte sizes, different size pages would make memory administration difficult. According to one embodiment of the invention, the pages may be assigned a unique number that identifies a location of the pages with memory 106. One of ordinary skill in the art will readily appreciate the various processes that may be employed to structure a memory into two or more pages.

According to one embodiment of the invention, the two or more pages of structured memory that reside on memory 106 may include a similar length and partition structure. According to another embodiment of the invention, the two or more pages of structured memory that reside on memory 106 may include different lengths and partition structure. According to yet another embodiment of the invention, the two or more pages of structured memory that reside on memory 106 may include a combination of a similar length, similar partition structures, different lengths and partition structures. According to one embodiment of the invention, the two or more pages of structured memory that reside on RFID tag 105 enable use of a single RFID tag to associate multiple objects that are defined in the two or more pages of structured memory.

According to one embodiment of the invention, RFID tags 105 may include read-only memory or read/write memory. According to one embodiment of the invention, the read-only memory may be programmed at a factory with serial number or other unalterable data. According to another embodiment of the invention, data that is stored on a read/write memory may be revised as needed. According to another embodiment of the invention, the read/write memory may be partitioned with a user-defined secure read-only portion and a reprogrammable read/write portion.

RFID interrogators 110 may include antennas 112a-112n (hereinafter antenna 112). Antennas 112 may be located at various strategic locations to interrogate the RFID tags, the strategic locations including loading bays, ceilings, walls, vehicles, and other strategic locations. RFID interrogators 110 may be of modular construction to facilitate adding, deleting, updating, and/or amending modules therein and/or features within modules. Modules may include memory, software, or other modules. According to one embodiment of the invention, RFID interrogators 110 may include a software component 111a-111n (hereinafter software 111) to obtain information regarding objects that RFID tags 105 are affixed to. According to another embodiment of the invention, server 125 may include a software component 127 that communicates with RFID interrogators 110 to obtain information regarding objects that RFID tags 105 are affixed to. According to yet another embodiment of the invention, the software component may reside on a combination of both the RFID interrogator 110 and server 125.

Software components 111 and 127 have various purposes and may be part of a single program or a collection of related components that operate together. In some cases, not all software will need to be used or are desired to be used. The software is purposefully designed to be flexible to permit features to be added and/or removed. Software components 111 and 127 may process RFID tag information and generate additional information, including location-based information, content-based information, environmental information and other additional information.

According to one embodiment of the invention, RFID interrogators 110 and/or server 125 may be provided with a user interface that enables users to interact with software components 111 and 127. According to one embodiment of the invention, the user interface may be configured to provide information, including, visual information, auditory information, visual tool, auditory options and/or other information. RFID interrogators 111 and server 125 also may include authentication features that request user credentials and validate users as authorized users.

Server 125 may include at least a processor, a memory, a display, and at least one input mechanism (e.g., a mouse or other input mechanism), among other features. According to one embodiment of the invention, the memory may be provided locally at server 125 to store information therein. According to another embodiment of the invention, the memory may be provided remotely from server 125 to store at a location other than at server 125. According to one embodiment of the invention, server 125 may be connected to RFID interrogators 110 via wired, wireless, and/or a combination of wired and wireless connections. According to another embodiment of the invention, server 125 may be connected to RFID interrogators 110 via one or more networks, including a wired network, a wireless network, a combination of wired and wireless networks or other networks.

Communications via network 115 may be implemented using current and future language conventions and/or current and future communications protocols that are generally accepted and used for generating and/or transmitting messages over network 115. Language conventions may include Physical Markup Language (“PML”), Hypertext Markup Language (“HTML”), extensible Markup Language (“XML”), and/or other language conventions. Communications protocols may include Hypertext Transfer Protocol (“HTTP”), TCP/IP, SSL/TLS, FTP, GOPHER, and/or other protocols.

FIG. 1 is provided for illustrative purposes only and should not be considered limitations of the invention. Other configurations will be appreciated by those skilled in the art and are intended to be encompassed by the invention.

For example, as alternatives to the embodiment illustrated in FIG. 1, server 125 may include any number of different types of servers, such as personal computers, laptop computers, smart terminals, or other servers.

According to one embodiment of the invention, RFID interrogators 110 and RFID tags 105 may exchange data using established standards. One RFID standard that is used in the supply chain environment is the EPCglobal Generation 2 (EPC Gen 2) UHF standard. The EPC Gen 2 UHF standard enables use of Electronic Product Code™ (EPC) numbers to uniquely identify objects that travel in the supply chain, including pallets, cases, individual products and/or other supply chain objects. EPC is divided into numbers that identify a manufacturer and product type. The EPC uses an extra set of digits, or a serial number, to identify unique items. The EPC provides a key to identify information about a product that exists in the EPCglobal Network. One of ordinary skill in the art will readily appreciate that the EPC memory structure is subject to change and that other non-EPC memory structures are contemplated by the invention. There is no intention to limit the scope of the invention only to the embodiments described below. As would be appreciated by those skilled in the art, the invention encompasses a broad spectrum of memory structures to include any and all modifications to known memory structures and any memory structures that will be designed in the future.

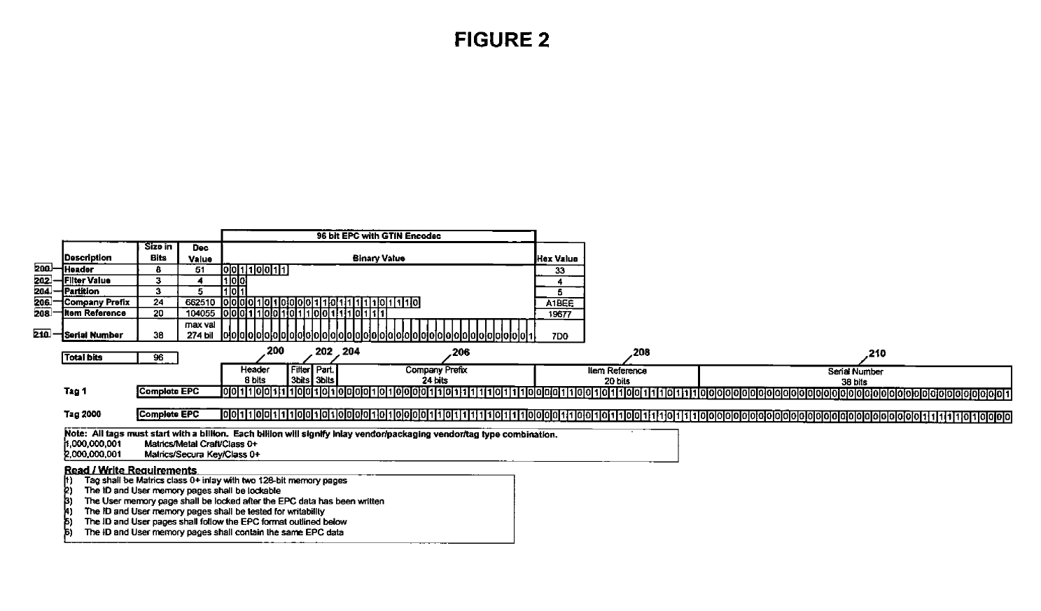

According to one embodiment of the invention illustrated in FIG. 2, RFID tags 105 may include a memory 106 that is configured to include a 96 bit EPC with GTIN encoded data structure. A general structure of EPC encodings is a string of bits that includes a tiered, variable length Header 200 that is followed by a series of numeric fields whose overall length, structure, and function are determined by the header value. In addition to Header 200, the numeric fields may include a Filter Value 202, a Partition 204, a Company Prefix 206, an Item Reference 208 and a Serial Number 210.

According to another embodiment of the invention, Header 200 may include a length of 8-bits. Filter Value 202 is not part of the GTIN or EPC identifier, but may be used for fast filtering and pre-selection of basic logistics types. For example, SGTINs may be assigned at several levels, including item, inner pack, case, pallet or other levels. RFID interrogators 110 may interrogate various levels and interrogating unneeded RFID tags 105 may slow down the RFID system. Thus, Filter Value 202 may be provided to “filter in” desired RFID tags 105 or “filter out” unwanted RFID tags 105.

Partition 204 is an indication of where the subsequent Company Prefix 206 and Item Reference 208 numbers are divided. Company Prefix 206 includes a literal embedding of the EAN.UCC Company Prefix. Item Reference 208 contains a literal embedding of the GTIN Item Reference number. Serial Number 210 contains a serial number. One of ordinary skill in the art will readily appreciate that other memory configurations may be used including Serial Shipping Container Code-96, Global Returnable Asset Identifier-96, Global Individual Asset Identifier-96, among other memory configurations. Additionally, while 96 bit structures are described herein, one of ordinary skill will readily appreciate that larger or smaller memory bit structures may be readily employed.

Conventional RFID systems use individually tagged objects and EPC standards to track objects in the supply chain. If association information is needed between objects and a corresponding returnable transport item due to a recall or contamination inquiry, conventional systems rely on software applications to search for and associate multiple RFID tags affixed to the individually tagged objects. Returnable transport items may include pallets, reusable plastic containers, intermediate bulk containers, automotive containers, or other returnable transport items.

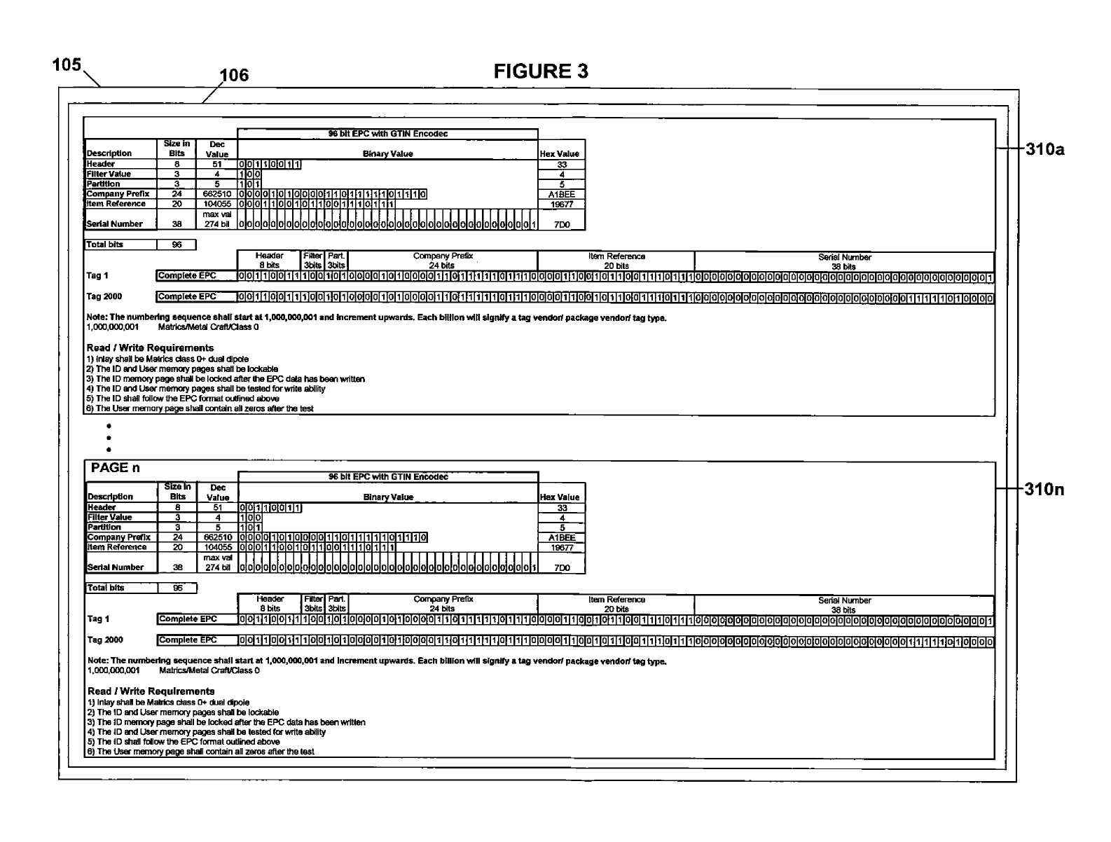

According to one embodiment, the invention enables one RFID tag 105 to be configured to associate multiple objects and corresponding returnable transport items that are defined in the two or more pages of structured memory. As illustrated in FIG. 3, an EPC 96 bit structure may be duplicated within a larger memory structure that may or may not include further extended memory for other non-EPC purposes. According to one embodiment of the invention, RFID tag 105 may be configured to be EPC compliant and may be further configured to include a first page of EPC structured memory 310 followed by further extended memory that incorporates at least one further page of EPC structured memory 31 On of similar length and partition. The invention provides a single RFID tag that may store multiple pages of a similar data structure to extend the capability of the single RFID tag to support multiple combinations of objects and/or returnable transport items. The single RFID tag may additionally include extended memory for specific non-EPC applications.

According to another embodiment of the invention, RFID interrogator 110 may communicate with server 125 to interrogate multiple pages of EPC structured data that is stored on RFID tag 105. Additionally, RFID interrogator 110 may communicate with server 125 to interrogate further extended memory for specific non-EPC applications.

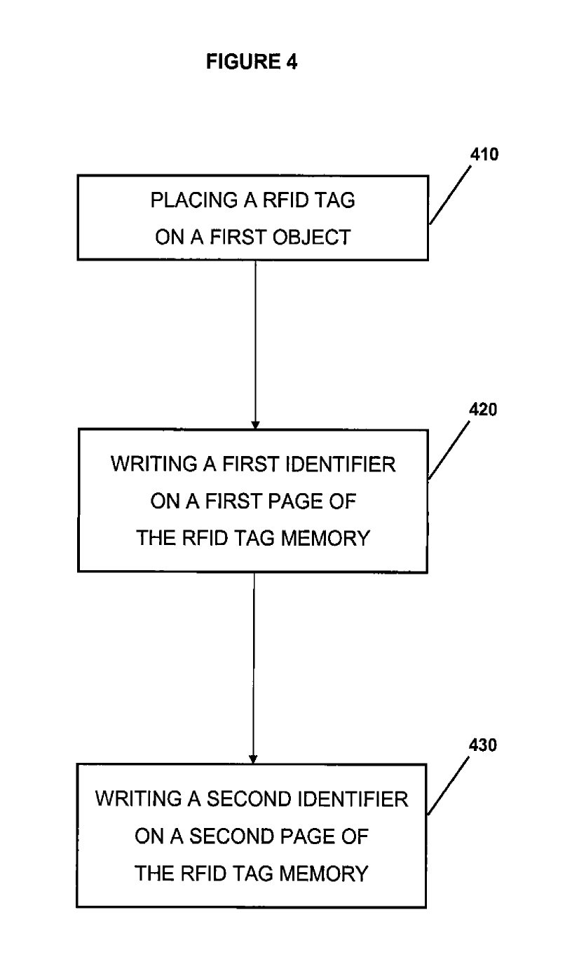

FIG. 4 illustrates a flow chart for associating two or more objects that travel in a supply chain. In operation 410, RFID tag 105 is placed on a first object, wherein RFID tag 105 includes a first page of structured memory and at least a second page of structured memory. In operation 420, a first identifier may be written on the first page of structured memory to identify the first object. The first object may be used to transport a second object. In operation 430, a second identifier may be written on a second page of structured memory to identify the second object. As a result, a single RFID tag may be used to associate two or more objects that are identified on at least two pages of memory within RFID tag 105.

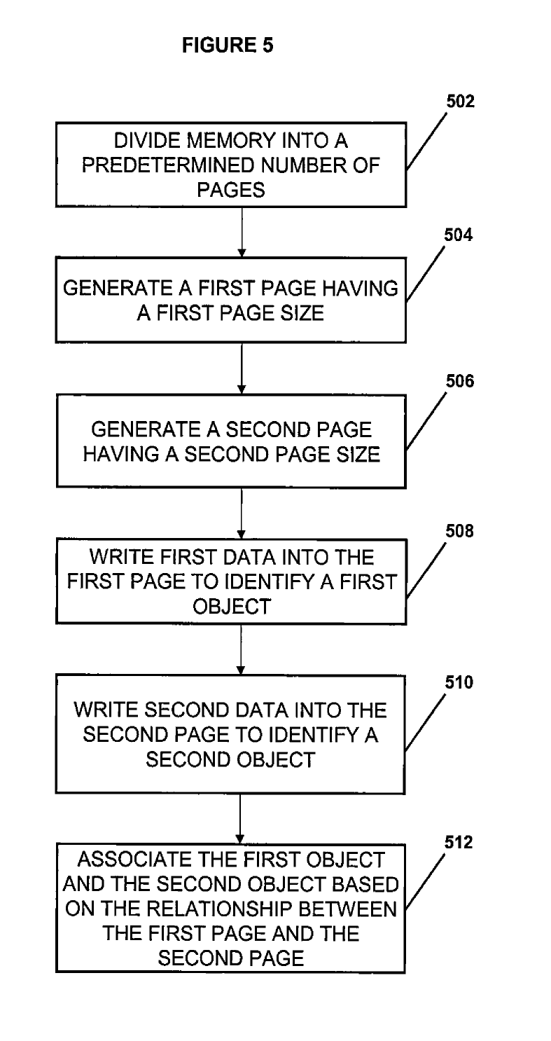

FIG. 5 illustrates a flow chart for configuring a memory of a radio frequency identification tag. In operation 502, the memory is divided into a predetermined number of pages. In operation 504, a first page is generated that includes a first page size. In operation 506, a second page is generated that includes a second page size. In operation 508, first data is written into the first page. In operation 510, second data is written into the second page, wherein the first data and the second data identify objects to be tracked by the radio frequency identification tag. In operation 512, the identified objects are associated based on a relationship between the first page and the second page.

While the preferred forms of the invention have been disclosed, it will be apparent to those skilled in the art that various changes and modifications may be made that will achieve some of the advantages of the invention without departing from the spirit and scope of the invention. For example, the system may be configured to support various other identifiers, including barcodes and/or other identifiers. It will be apparent to those reasonably skilled in the art that other components performing the same function may be suitably substituted. Further, the methods of the invention may be achieved in either all software implementations, using the appropriate processor instructions, or in hybrid implementations that utilize a combination of hardware logic and software logic to achieve the same results. Therefore, the scope of the invention is to be determined solely by the appended claims.

We claim:

1. A radio frequency identification system, comprising:
a radio frequency identification tag that includes a memory comprising:
a first page having a page size that is defined by a first predetermined number of bytes; and
a second page having a page size that is defined by a second predetermined number of bytes, wherein the first page and the second page include data that identifies objects to be tracked by the radio frequency identification tag;
a radio frequency identification interrogator that is configured to interrogate the radio frequency identification tag; and
a server that communicates with the radio frequency identification interrogator to interrogate the first page and the second page, wherein the identified objects are associated based on a relationship between the first page and the second page.

2. The radio frequency identification system according to claim 1, wherein the first page and the second page include Electronic Product Code™ compliant data.

3. The radio frequency identification system according to claim 1, wherein the first page and the second page include non-Electronic Product Code™ compliant data.

4. The radio frequency identification system according to claim 2, wherein the Electronic Product Code™ compliant data includes (i) Serial Shipping Container Code, (ii) Global Returnable Asset Identifier, (iii) Global Individual Asset Identifier, or any combination of (i) to (iii).

5. The radio frequency identification system according to claim 1, wherein the first page and the second page include a same page size and partition structure.

6. A radio frequency identification tag, comprising:
a memory comprising:
a first page having a page size that is defined by a first predetermined number of bytes; and
a second page having a page size that is defined by a second predetermined number of bytes, wherein the first page and the second page include data that identifies objects to be tracked by the radio frequency identification tag and wherein the identified objects are associated based on a relationship between the first page and the second page.

7. The radio frequency identification tag according to claim 6, wherein the first page and the second page include Electronic Product Code™ compliant data.

8. The radio frequency identification tag according to claim 6, wherein the first page and the second page include non-Electronic Product Code™ compliant data.

9. The radio frequency identification tag according to claim 7, wherein the Electronic Product Code™ compliant data includes (i) Serial Shipping Container Code, (ii) Global Returnable Asset Identifier, (iii) Global Individual Asset Identifier, or any combination of (i) to (iii).

10. The radio frequency identification tag according to claim 6, wherein the first page and the second page include a same page size and partition structure.

11. A method of associating two or more objects that travel in a supply chain, comprising:
placing a radio frequency identification tag on a first object, wherein the radio frequency identification tag includes a first page having a first page size and a second page having a second page size;
writing, on the first page, a first identifier that identifies the first object;
using the first object to transport a second object; and
writing, on a second page, a second identifier that identifies the second object.

12. The method according to claim 11, wherein the first page and the second page include Electronic Product Code™ compliant data.

13. The method according to claim 11, wherein the first page and the second page include non-Electronic Product Code™ compliant data.

14. The method according to claim 12, wherein the Electronic Product Code™ compliant data includes (i) Serial Shipping Container Code, (ii) Global Returnable Asset Identifier, (iii) Global Individual Asset Identifier, or any combination of (i) to (iii).

15. The method according to claim 11, wherein the first page size and the second page size include a same byte size.

16. The method according to claim 15, wherein the first page and the second page include a same partition structure.

17. A method of configuring a memory for a radio frequency identification tag, comprising:
dividing the memory into a predetermined number of pages;
generating a first page that includes a first page size;
generating a second page that includes a second page size;
writing first data into the first page;
writing second data into the second page, wherein the first data and the second data identify objects to be tracked by the radio frequency identification tag, and wherein the identified objects are associated based on a relationship between the first page and the second page.

18. The method according to claim 17, wherein the first page and the second page include Electronic Product Code™ compliant data.

19. The method according to claim 17, , wherein the first page and the second page include non-Electronic Product Code™ compliant data.

20. The method according to claim 17, wherein the first page size and the second page size include a same byte size.
